(19) United States
(12) Patent Application Publication
(10) Pub. No.: US 2018/0186396 A1
(43) Pub. Date: Jul. 5, 2018

(54) MINIATURIZED BABY WALKER

(71) Applicant: Leona Rousseau, Marksville, LA (US)

(72) Inventor: Leona Rousseau, Marksville, LA (US)

(21) Appl. No.: 15/393,871

(22) Filed: Dec. 29, 2016

(51) Int. Cl. B62B 9/12; A47D 13/04; B62B 7/00; B62B 9/24

(52) U.S. Cl. CPC B62B 9/12; B62B 9/24; B62B 7/006; A47D 13/043

(57) ABSTRACT

A miniaturized, customizable baby walker for smaller infants who may be in the six to eight month age range. The miniaturized baby walker includes modular frame having a rectangular top portion and a rectangular bottom portion which are connected by four vertical supports. Extending downward adjacent to each corner of the bottom portion is a wheel assembly which allows the baby walker to roll on a substantially flat surface. Extending outwardly from a central position of each face of the bottom portion is a stopper which prevents tipping and crashing into objects. A seat member having a seating portion attached to a rigid seat frame that includes front and rear coupling portions is attached to the top portion so as to provide a place for an infant to be seated.

### BACKGROUND OF THE INVENTION

### Field of the Invention

This invention relates generally to occupant pushed vehicles and, more particularly, to a miniaturized baby walker for smaller infants.

### Description of the Prior Art

The use of baby walkers by infants who cannot walk on their own is well known. Conventional walkers generally include a rigid base that includes a plurality of wheels and a seat. A problem which still exists, however, is that many conventional baby walkers are relatively large and difficult to maneuver in smaller dwellings. Moreover, they often have a fixed number of height settings which can make it difficult to customize for a given child. Thus, there remains a need for a miniaturized baby walker that has a small profile that does not extend beyond the reach of an infant. It would be helpful if such a miniaturized baby walker included removable vertical supports so as to allow for unlimited height customization. It would be additionally desirable for such a miniaturized baby walker to include a plurality of stoppers to prevent crashes into nearby objects.

The Applicant's invention described herein provides for a miniaturized baby walker adapted to allow a baby to move around upright without bumping into nearby objects. The primary components in Applicant's miniaturized baby walker are a modular frame, wheels, stoppers, and a seat. When in operation, the miniaturized baby walker provides a highly customizable apparatus that is easy for an infant to maneuver. As a result, many of the limitations imposed by prior art structures are removed.

### SUMMARY OF THE INVENTION

A miniaturized, customizable baby walker for smaller infants who may be in the six to eight month age range. The miniaturized baby walker comprises modular frame having a rectangular top portion and a rectangular bottom portion which are connected by four vertical supports. Extending downward adjacent to each corner of the bottom portion is a wheel assembly which allows the baby walker to roll on a substantially flat surface. Extending outwardly from a central position of each face of the bottom portion is a stopper which prevents tipping and crashing into objects. A seat member having a seating portion attached to a rigid seat frame that includes front and rear coupling portions is attached to the top portion so as to provide a place for an infant to be seated.

It is an object of this invention to provide a miniaturized baby walker that has a small profile that does not extend beyond the reach of an infant.

It is another object of this invention to provide a miniaturized baby walker which includes removable vertical supports so as to allow for unlimited height customization.

It is yet another object of this invention to provide a miniaturized baby walker which includes a plurality of stoppers to prevent crashes into nearby objects.

These and other objects will be apparent to one of skill in the art.

### BRIEF DESCRIPTION OF THE DRAWINGS

FIG. 1 is a rear perspective view of a miniaturized baby walker built in accordance with the present invention.

FIG. 2 is an exploded side elevational view of a modular frame of a miniaturized baby walker built in accordance with the present invention.

### DETAILED DESCRIPTION OF THE INVENTION

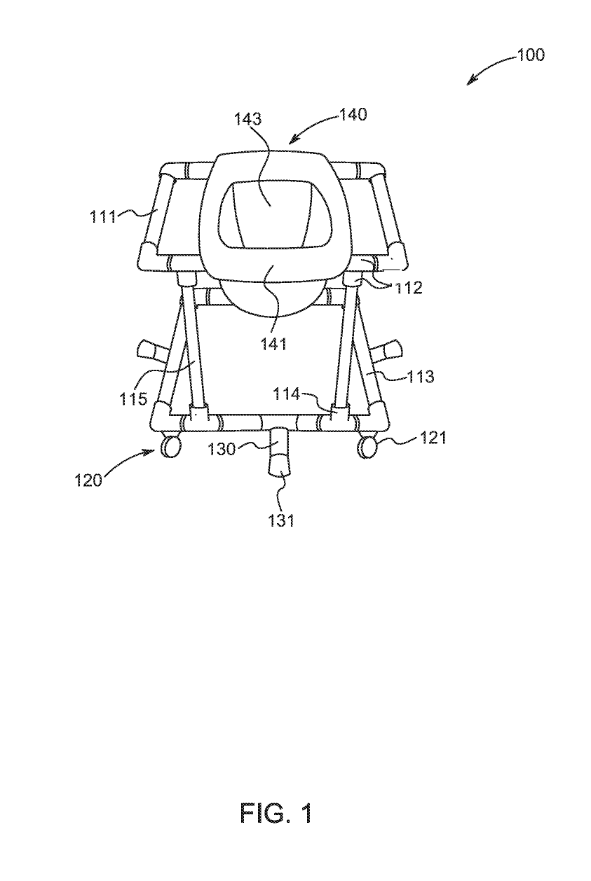

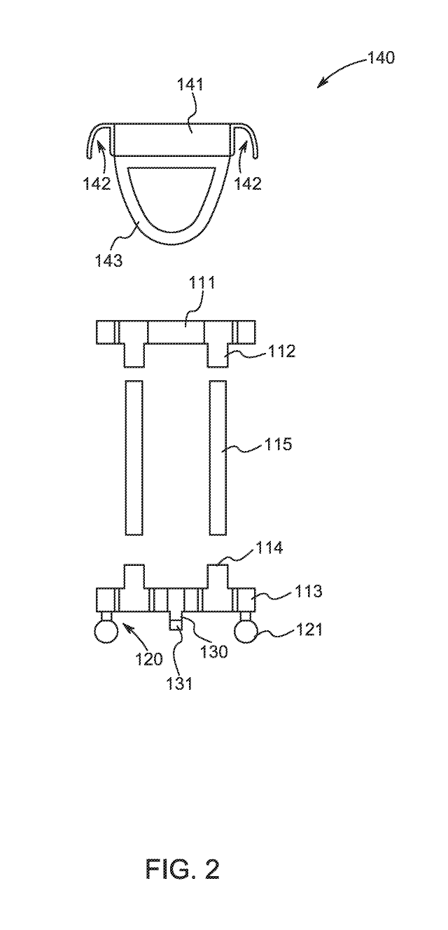

Referring now to the drawings and in particular FIGS. 1 and 2, a miniaturized baby walker 100 is shown having a modular frame 110, a plurality of wheel assemblies 120, a plurality of stoppers 130, and a seat member 140. The modular frame 110 includes a rectangular top portion 111, a rectangular bottom portion 113, and four vertical supports 115, with the top portion 111 including four top support holders 112 which extend downward from the top portion 111 and the bottom portion 113 including four bottom support holders 114 which extend upward from the bottom portion 113. With respect to their size and shape, as well as the positioning of the respective top support holders 112 and bottom support holders 114, the top portion 111 and bottom portion 113 define mirror image structures. In one embodiment, the components of the modular frame 110 are constructed of polyvinyl chloride (PVC) pipe sections and fittings.

Each of the top support holders 112 and bottom support holders 114 define a receptacle sized to receive and hold one end of one of the vertical supports 115 with the end of the vertical support 115 frictionally secured therein. When the modular frame 110 is assembled, each of the vertical supports 115 is secured at one end in one of the top support holders 112 and at the other end in the bottom support holder 114 that positionally corresponds to the top support holder 112 in which the vertical support 115 is secured. In this regard, the top portion 111 is attached to and positioned directly above the bottom portion 113 through the vertical supports 115.

Extending downwardly adjacent to each corner of the bottom portion 113 is one of the wheel assemblies 120. Each of the wheel assemblies 120 include a wheel 121 which allows the miniaturized baby walker 100 to roll. In one embodiment, each of the wheel assemblies 120 includes a swivel so as to allow the wheel assembly 120 to revolve, while in another embodiment, only two of the wheel assemblies 120 swivel and the others are fixed.

Extending outwardly from each face of the bottom portion 113 is one of the stoppers 130. In one embodiment, each stopper 130 extends from the bottom portion 113 at a 315 degree angle (i.e. 45 degrees downward from the plane formed by the bottom portion 113) and includes a rubber tip 131. It is contemplated that the stoppers 130 prevents the miniaturized baby walker 100 from tipping over and reduces the possibility for the modular frame 110 to directly impact by walls or other objects.

It is appreciated that the vertical supports 115, top support holders 112, and bottom support holders 114 are positioned on the front side of the modular frame 110 just as they are positioned on the rear side (as illustrated in FIG. 1).

In one embodiment, the seat member 140 includes a rigid seat frame 141 having an open middle disposed between front and rear coupling portions 142 and a seating portion 143 that extends down from the seat frame 141, is positioned in the open middle of the seat frame 141, and includes a pair of leg holes to allow an infant to be seated therein with their legs extending out of the seating portion 143. In one embodiment, the front and rear coupling portions 142 are positioned, sized, and shaped to engage opposing sides of the top portion 111, as illustrated in FIG. 1, so that the seat member 140 is suspended from the top portion 111. In one embodiment, the rigid seat frame 141 is constructed of plastic and the seating portion 143 is constructed of fabric. In another embodiment, the seating portion 143 is also constructed of hard plastic.

In one embodiment, each of the top portion 111 and bottom portion 113 is 11½ inches long (sides) and 14 inches wide (front and rear). In one embodiment, there is a 2¾ inch space between the seat member 140 and the sides of the top portion 111. In one embodiment, there is a 7½ inch space between the two vertical supports 115 which are attached to the same side of the top portion 111/bottom portion 113.

In is contemplated that vertical supports 115 having a length between 10 inches and 18 inches may be employed to account for young infants of varying sizes. For example, it is contemplated that the miniaturized baby walker 100 may be sized in the way to be employed with infants between the ages of four and eight months. For a four month old, the seat member 140 may be as low as 6 inches from the floor and the vertical supports 115 may measure 15 inches. For an eight month old, the seat member 140 may be 8 inches from the floor and the vertical supports 115 may measure 18 inches

In one embodiment, vertical supports 115 of varying length can be used to modify the height of the frame 110. In such an embodiment, because tehe vertical supports 115 are held in the top portion 111/bottom portion 113 through frictional engagement only, an end user can readily remove and replace them. Moreover, because the frame 110 may be constructed of readily available PVC pipe, it is appreciated that vertical supports 115 of any length may be readily obtained.

In one embodiment, the vertical supports 115 are telescopically adjustable in length as opposed to being replaceable to allow for the height of the frame 110 to be adjusted.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A miniaturized baby walker, comprising:
a modular frame having a planar top portion and a planar bottom portion, wherein said top portion and bottom portion are attached together through a plurality of discrete, elongated vertical supports with the top portion positioned horizontally above the bottom portion;
at least one stopper attached to said bottom portion, wherein said at least one stopper is oriented so as to extend outwardly from the bottom portion;
a plurality of wheel assemblies attached to said bottom portion so as to extend downwardly from the bottom portion, wherein said wheel assemblies each have at least one wheel; and
a seat member configured to receive a seated infant and adapted to engage said top potion in two separate locations so as to be suspended from said top portion.

2. The miniaturized baby walker of claim 1, wherein said top portion and bottom portion are attached together such that the plane of the top portion and the plane of the bottom portion are parallel.

3. The miniaturized baby walker of claim 2, wherein said top portion and bottom portion are rectangular.

4. The miniaturized baby walker of claim 3, wherein said top portion includes a front side and a back side.

5. The miniaturized baby walker of claim 4, wherein said seat member includes a rigid seat frame having an open middle disposed between a front coupling portion and a rear coupling portion so as to adapt the seat member to engage the front side and back side of said top portion.

6. The miniaturized baby walker of claim 5, wherein said seat member includes a seating portion positioned in the open middle that extends down from the seat frame.

7. The miniaturized baby walker of claim 1, wherein:
said top portion includes a plurality of top support holders extending downward therefrom;
said bottom portion includes a plurality of bottom support holders extending upward therefrom;
each of the top support holders and bottom support holders define a receptacle sized to receive and hold an end of one of the vertical supports with the end of the vertical support frictionally secured therein; and
each of said vertical supports attach at one end to one of said top support holders and at the other end to one of said bottom support holders.

8. The miniaturized baby walker of claim 7, wherein each of the bottom support holders positionally corresponds to one of the top support holders such that the top support holder is and positioned directly above the corresponding the bottom support holder.

9. The miniaturized baby walker of claim 1, wherein said seat member includes a rigid seat frame having an open middle disposed between a front coupling portion and a rear coupling portion so as to adapt the seat member to engage said top portion in two separate locations so as to be suspended from said top portion.

10. The miniaturized baby walker of claim 9, wherein said seat member includes a seating portion positioned in the open middle that extends down from the seat frame.
